(19) United States
(12) Patent Application Publication
(10) Pub. No.: US 2003/0229655 A1
(43) Pub. Date: Dec. 11, 2003

(54) ClientSync - a synching method between a client computer or computers and server computer supporting one-to-many and many-to-one database synchronization when the network connection between the two is not always available or is a low-speed connection.

(75) Inventors: Charles Bibas, Searingtown, NY (US); Zion Shivat, Ramleh (IL)

Correspondence Address: ADVANCED BARCODE TECHNOLOGY, INC., 525 NORTHERN BLVD., GREAT NECK, NY, 11021, US

(73) Assignee: ADVANCED BARCODE TECHNOLOGY, INC., Great Neck, NY (US)

(21) Appl. No.: 10/250,086

(22) Filed: Jun. 3, 2003

Related U.S. Application Data
(60) Provisional application No. 60/386,595, filed on Jun. 6, 2002.

(51) Int. Cl. G06F 12/00

(52) U.S. Cl. 707/203

(57) ABSTRACT

ClientSync is a module that allows a client computer or workstation to communicate with a central database stored on a server. When a network connection is present between the client and the server, the Sync application, running on a PC, allows the user to select a database which will then have its data re-created on the server. The data from the server will then be written back to the local database, thus ensuring all records are up-to-date.

### BACKGROUND OF INVENTION

In a typical centralized database system, a client computer connects over a network to a server, which stores the database. The client makes a request of the server, then the server handles all of the database operations (querying, adding or updating records, etc.). However, when a network link is slow or when the link is down, a client computer cannot connect effectively to the central database. This causes a delay in data manipulation as well as productivity losses since the computer operator cannot perform his or her duties without access to the server.

This situation can be avoided by storing a subset of the central database locally on the client computer. Any manipulations made by the operator are stored locally, until such time as a good network connection is available.

When the connection is available, the user can either execute the Sync program or let the ClientSync scheduler execute the program. The newly added records are copied to a corresponding table in the central database, then a set of basic instructions is performed which writes the data into the actual data table or tables. The data is then copied back from the central database to the user's local database, thus ensuring that each user who performs the sync function has an up-to-date database.

### SUMMARY OF INVENTION

It is the object of this invention to allow a primary database, stored on a host computer (laptop device or desktop device) to be updated with information stored in a database on a handheld computer (PDA). The data on the handheld can be updated as well.

### DETAILED DESCRIPTION

The solution is based on having a local copy or a subset of the central database. The subset copy can be accessed by the operator when the link is down. All operations on this subset database are saved in a log file or a table. When the link is up a small program kicks in and synchs the central database with the client subset (local) database. The synchronization process works as follows:

1. The synch program runs through the log file (or table) and reads the operations performed on the local data base.

2. The synch program re-runs these operations (from the log file) in the central database and performs the changes

3. The central database maintains its own log file, so when (1) the sync program at the client performs the change it is always looking to see if that record or field was changed by another client or server and if so, it sets this record aside for the server to handle (4).

4. After the sync process the server will end up with a collision list (records which were changed by more than one client). If the administrator configuration allows for auto-handling then the server will sort the collision by date/time and perform the operation(s) on the central database (earliest first). All of these operations will be kept in a log file so an undo can be performed by the operator.

The outcome of the above is that a record is not changed as in a traditional synch process, but, rather, the operation (from the log file) is driving the sync. That way the sync process is synchronizing the operation itself, but not the record. The result is a record change and/or field change.

After the Sync is completed, the local database will contain not just the data generated by that user, but data from all other users as well.

What is claimed is:

1. A system for synchronizing data between one or more local databases and one or more central databases comprising:
local database(s), stored on a client computer, or multiple computers; central database(s), stored on a server or servers;
a program interface, stored on and run from the host computer, which allows the user to select which primary database is to be synchronized with the secondary database, then performs the operation at timed intervals and/or at the command of the user.

2. The system of claim 1 wherein a network connection connects the client computer and the server.

3. The system of claim 1 wherein the central database is in a different format from the local database.

4. The system of claim 1 wherein data from the local database is written into a special table in the central database.

5. The table of claim 4 wherein the data in said table is translated as a series of instructions which will perform the operations necessary to re-create the data which will be stored in the central database.

6. The system of claim 1 wherein only records created on the local database subsequent to the previous synch procedure will be used in the current synch procedure.

7. The sequence of instructions in claim 5 are standard database operations which are compiled into the Sync program in claim 1.

8. The system of claim 1 wherein data from the central database is written to the local database, bringing it up to date.

9. The system of claim 8 is regulated by a version number, whereby, if the version numbers in the central and local databases are the same, no operation is performed, but if the numbers differ, the data record is copied from the central to the local.
